(19) United States
(12) Patent Application Publication
(10) Pub. No.: US 2011/0135012 A1
(43) Pub. Date: Jun. 9, 2011

(54) METHOD AND APPARATUS FOR DETECTING DARK NOISE ARTIFACTS

(76) Inventors: Zhen Li, Burbank, CA (US); Adeel Abbas, Plainsboro, NJ (US); Xiaoan Lu, Princetyon, NJ (US); Cristina Gomila, Princeton, NJ (US)

(21) Appl. No.: 12/737,661

(22) PCT Filed: Aug. 8, 2008
(86) PCT No.: PCT/US2008/009566

§ 371 Date: Feb. 4, 2011

(51) Int. Cl. H04N 11/02

(52) U.S. Cl. 375/240.29; 375/E07.026

(57) ABSTRACT

The present invention involves detecting dark noise artifacts in coded images and video. Locations of artifacts in compressed pictures are found. A strength of the artifact per block is determined as is an overall dark noise artifact strength for each picture. Artifact detection and strength assignment is performed by analyzing candidate areas that could be prone to this type of artifact. Multiple features such as block variance, color information, luminance levels and location of the artifact could be used in this process. Also, median filtering may be used on the identified areas to eliminate isolated areas. A final artifact parameter for each picture can be assessed based on the total number of blocks that are classified as dark noise and also the strength of each macroblock.

### BACKGROUND

1. Technical Field

Principles of the present invention relate to digital image and video content. More particularly, they relate to detecting dark noise artifacts in digital image and video content.

2. Description of the Related Art

Non-real time video coding applications such as DVD authoring, aim at achieving the best possible visual quality for an image from a compression engine. To that goal, compressionists (i.e., the technicians responsible for the compression process) are required to review the compressed video in order to identify pictures with artifacts. This is a manual and subjective process that requires substantial experience, time and effort affecting the production time and budget. It is also subject to inconsistency due to different visual evaluation standards imposed by different evaluators. In common practice, detected pictures are post-processed or re-encoded with fine-tuned encoding parameters and subject to further review. The post-processing or re-encoding algorithms can tune their parameters based on the artifact parameter and locations in order to get better picture quality.

In this context, automatic artifact detection is needed to facilitate the process. In order to automatically identify a problematic scene or segment, it is essential to find objective metrics that detect the presence of compression artifacts. Detection of common compression artifacts caused by MPEG-2 encoding, such as blockiness, blurriness and mosquito noise, has been extensively studied in the past. However, this is a difficult problem not properly handled by conventional and widely-accepted objective metrics such as the Peak Signal-to-Noise-Ratio (PSNR). Furthermore, the use of new compression standards such as MPEG-1 AVC or VC-1 jointly with the fact that the new High Definition DVD formats operate at higher bit-rates has brought into play new types of compression artifacts.

The term dark noise describes a particular type of visual artifact introduced by these new compression systems. A compressed image is said to have dark noise artifacts when clusters of artificially flattened blocks are perceived in areas that exhibit (1) low variance, (2) low intensity level and (3) low saturation. Dark noise artifacts may include severe blockiness and/or variations on the perceived chroma pattern.

To efficiently support the applications described above, a dark noise artifact detection algorithm needs to provide a parameter that represents the severity of the artifact such that re-encoding and post-processing algorithm could automatically prioritize the allocation of resources within the project constraints. Furthermore, a dark noise artifact detection algorithm needs to provide the parameter not only on a global level such as a group of pictures or one picture, but also on a local level such as a macroblock or block inside a picture. By locating the dark noise artifact to the local level, an encoding or processing module can adjust the encoding or processing parameters in the artifact areas only, which can be particularly useful when the overall bit budgets or computational resources are limited.

Consequently, there is a strong need for a method and apparatus that automatically detects dark noise artifacts and determines the strength of the artifact per block and per picture.

### SUMMARY

According to one aspect of the present invention, a method and apparatus for detecting dark noise artifacts in coded images and video. The method: (i) finds the locations of the artifacts in the compressed pictures, (ii) determines the strength of the artifact per block, and (iii) determines overall dark noise artifact strength for each picture. Artifact detection and parameter assignment is performed by analyzing candidate areas that could be prone to this type of artifact. Multiple features such as block variance, color information, luminance levels and location of the artifact could be used in this process. In an exemplary implementation A method for detecting dark noise artifacts is proposed comprising the steps of screening candidate dark noise artifact areas in a digital image based on at least one feature of the area, filtering the screened candidate areas to eliminate isolated artifact areas, assigning a dark noise artifact parameter to each candidate area, and forming a dark noise artifact parameter for a set of pixels in the candidate area.

According to another aspect of the present invention, a video encoder is proposed comprising a dark noise artifact detector configured to screen candidate dark noise artifacts areas of a digital image based on at least one feature of the area, eliminate isolated artifact areas, assign a dark noise artifact strength to each candidate area, and calculate a dark noise artifact parameter for a set of pixels.

Other aspects and features of the present invention will become apparent from the following detailed description considered in conjunction with the accompanying drawings. It is to be understood, however, that the drawings are designed solely for purposes of illustration and not as a definition of the limits of the present invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings wherein like reference numerals denote similar components throughout the views:

FIG. 1 is flow diagram of the method for detecting dark noise artifacts according to an implementation of the present principles;

FIG. 2 is a detailed flow diagram of the method for detecting dark noise artifacts according to an implementation of the present principles;

FIG. 3 is a block diagram of a rate control algorithm that could apply the method for dark noise artifact detection according to an implementation of the present principles; and

FIG. 4 is a block diagram of a predictive encoder incorporating the method for dark noise artifact detection according to an implementation of the present principles.

### DETAILED DESCRIPTION

The present principles proposes a method and an apparatus to (i) find the locations of the dark noise artifacts, (ii) determine the strength of the dark noise artifact per block, and (iii) determine overall dark noise artifact strength per picture.

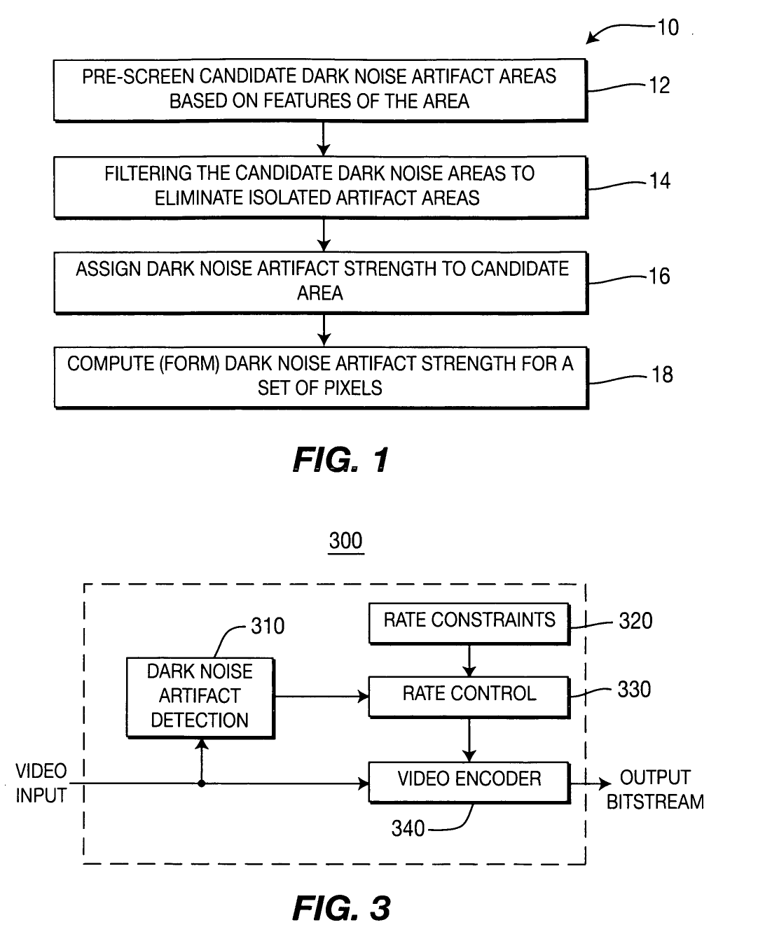

Dark noise artifact detection described by the present principles can include part or all of the following steps. Referring to the method 10 shown in FIG. 1, the dark artifact detection is performed by first screening (12) the targeted picture or pictures and locating the candidate dark noise artifact areas. A filter is applied (14) on these candidates to eliminate the isolated areas. At this point, a dark noise artifact strength is assigned (16) to each candidate artifact block, which can be further used to determine or form (18) the artifact strength for a set of pixels (e.g., a picture or a group of pictures). The strength value can then be compared against a threshold automatically by the video encoder, or the metric can be presented to a compressionist who will determined the need for re-encoding on an individual case basis. We explain these steps in the following.

### (a) Dark Noise Artifact Area Screening

The screening of step 12 in FIG. 1 is used to attempt to eliminate the areas where typical dark noise artifacts are unlikely to occur and hence speed-up the dark noise artifact detection. The screening step and filtering steps eliminate or reduce dark noise artifacts within the areas. The prescreening can be done on a pixel level or a group of pixels level. A number of features in the pixel domain or the transform domain can be used to eliminate unlikely candidates. As an exemplary implementation, the following features are computed on an 8×8 block,

MeanLumRec=Mean of the luma component of the reconstructed block
MeanCbRec=Mean of the Cb chroma component of the reconstructed block
MeanCrRec=Mean of the Cr chroma component of the reconstructed block
VarLumRec=Variance of the luma component of the reconstructed block
VarLumOrg=Variance of the luma component of the original block
Where the variance \tilde{B} of the pixel values in a block B of size M×N is computed as

$$\tilde{B} = \frac{1}{M \times N} {\sum }_{i = 1}^{M} {\sum }_{j = 1}^{N} {( B ( i , j ) - \overline{B} )}^{2}$$

B(i,j) represents the pixel value at position (i,j) in the block B, and B̅ represents the mean of the pixel values within the block B and it is computed as

$$\tilde{B} = \frac{1}{M \times N} {\sum }_{i = 1}^{M} {\sum }_{j = 1}^{N} B ( i , j )$$

In this example, a block that satisfies the following criteria is classified as a candidate dark noise artifact area. A block that is classified as candidate dark noise artifact area is marked as 1, otherwise it is marked as 0.
1) MeanLumRec is in a pre-determined range TH_LUM_LOW, TH_LUM_HI);
2) VarLumRec is less than a predetermined value TH_LUM_VAR;
3) The absolute value of the difference between VarLumOrg and VarLumRec is greater than a pre-determined value TH_LUM VARDIFF;
4) MeanCbRec and MeanCrRec are within the rage (TH_CR_LOW, TH_CB_HI) and (TH_CR_LOW, TH_CR_HI, respectively.
   As mentioned above, other criteria (i.e., other than luminance information) can be used during the screening step. Other examples of area features that can be used to screen candidate dark noise artifact areas can include spatial activity information, texture information, or temporal information.

### (b) Candidate Dark Noise Artifact Areas Filtering

Once the candidate dark noise artifact areas are identified, a temporal and/or spatial filter (step 14) can be used on these areas to reduce or eliminate the isolated regions. In the exemplary implementation, we use a spatial median filter to filter out the isolated candidate dark noise artifact macroblocks inside a video frame.

### (c) Dark Noise Artifact Strength for a Block

Based on the characteristics of a candidate dark noise artifact block, artifact strength can be assigned to this block. In the present example, we assign higher strength to blocks with lower average luminance values. This is due to the fact that the artifacts tend to be more severe in low luminance areas. If the original image or video is available, we can further compute the variance of each block for both the original and reconstructed image or video, and the candidate reconstructed block with greater decrease in variance is assigned with higher artifact strength. As a particular embodiment, the artifact strength for a block (Art if act Strength) can be computed as follows,

VarDiff=VarLumOrg−VarLumRec

LumaWt=(TH_LUM_HI−MeanLumRec)/(TH_LUM_HI−TH_LUM_LOW)

ArtifactStrength=VarDiff+LumaWt

Those of skill in the art will recognize that the artifact strength can be assigned on a macroblock level or on a picture level.

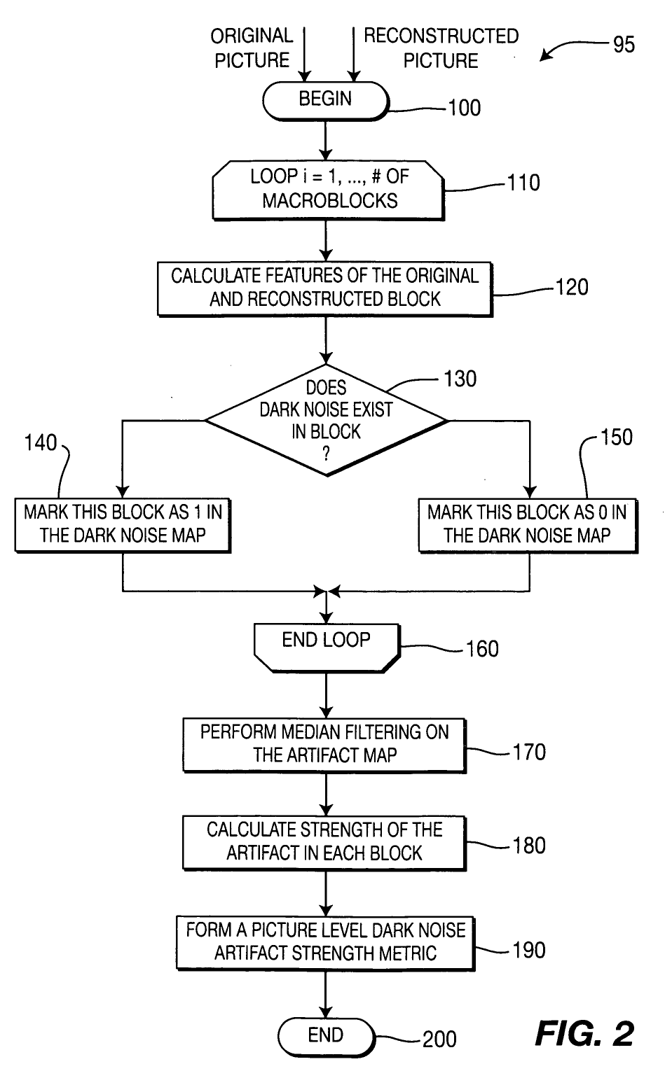

FIG. 2 illustrates a flow diagram 95 of a block level dark noise artifact detection module according to an implementation of the present principles. As mentioned above, for each block in a picture, the dark noise artifact detection method first screens and eliminates the unlikely artifact candidate areas using different features. This is shown by steps 100-120 of FIG. 2. Initially when the process begins (100), a loop through the macroblocks is performed (110), and features of the original and reconstructed blocks are calculated (120).

A determination is then made (130) as to whether dark noise exists in the respective block. When yes, the detected dark noise artifact candidate is marked as 1 in the mask map (140), otherwise marked as 0 (150). At this point the loop through the macroblocks is ended (160).

The median filtering is then performed on the mask map to eliminate the isolated areas (170). After the median filtering, dark noise artifact strength for a group of pixels such as a block can be calculated (180). Based on the strength calculation, the artifact strength for a picture can be formed (190), and the process then ends (200).

### (d) Dark Noise Artifact Metric for an Image or a Group of Video Pictures

Once the candidate artifact blocks are identified and artifact strength is assigned to each block, the overall dark noise artifact strength can be computed (or formed) for an image or a group of video pictures (step 18). An example of computing the overall dark noise artifact strength is to use the percentage of blocks that are identified as candidate artifact blocks inside the image or video pictures. Another example of computing the overall artifact strength can be summing up the artifact strength for every block. The overall artifact strength can then be compared against a threshold automatically by the video encoder, or the metric can be presented to a compressionist who will determined the need for re-encoding on an individual case basis.

For areas or pictures that are identified with dark noise artifacts exceeding the desired threshold, a rate control algorithm can be used to adjust the encoding parameters for re-encoding. A simple example of such rate control is to allocate more bits to areas or pictures with dark noise artifacts using bits from areas or pictures without dark noise artifacts (see, for example, FIG. 3).

FIG. 3 illustrates the block diagram of a rate control algorithm 300 that could apply the dark noise artifact detection method 10 shown and described in FIGS. 1-2. Turning to FIG. 3, an exemplary apparatus for rate control to which the present principles may be applied is indicated generally by the reference numeral 300. The apparatus 300 is configured to apply dark noise artifact parameters estimation described herein in accordance with various embodiments of the present principles. The apparatus 300 comprises a dark noise artifact, detector 310, a rate constraint memory 320, a rate controller 330, and a video encoder 340.

An output of the dark noise artifact detector 310 is connected in signal communication with a first input of the rate controller 330. The rate constraint memory 320 is connected in signal communications with a second input of the rate controller 330. An output of the rate controller 330 is connected in signal communication with a first input of the video encoder 340.

An input of the dark noise artifact detector 310 and a second input of the video encoder 340 are available as inputs of the apparatus 300, for receiving input video and/or image(s). An output of the video encoder 340 is available as an output of the apparatus 300, for outputting a bitstream.

In one exemplary embodiment, the dark noise artifact detector 310 generates a dark noise artifact parameter according to the methods described according to FIGS. 1-2 and passes said metric to the rate controller 330. The rate controller 330 uses this dark noise artifact parameter along with additional rate constraints stored in the rate constraint memory 320 to generate a rate control parameter for controlling the video encoder 340. Alternatively, the artifact parameter can be stored in a memory, where said dark noise artifact parameter can later be retrieved and a decision can be made as to when re-encoding is required or not.

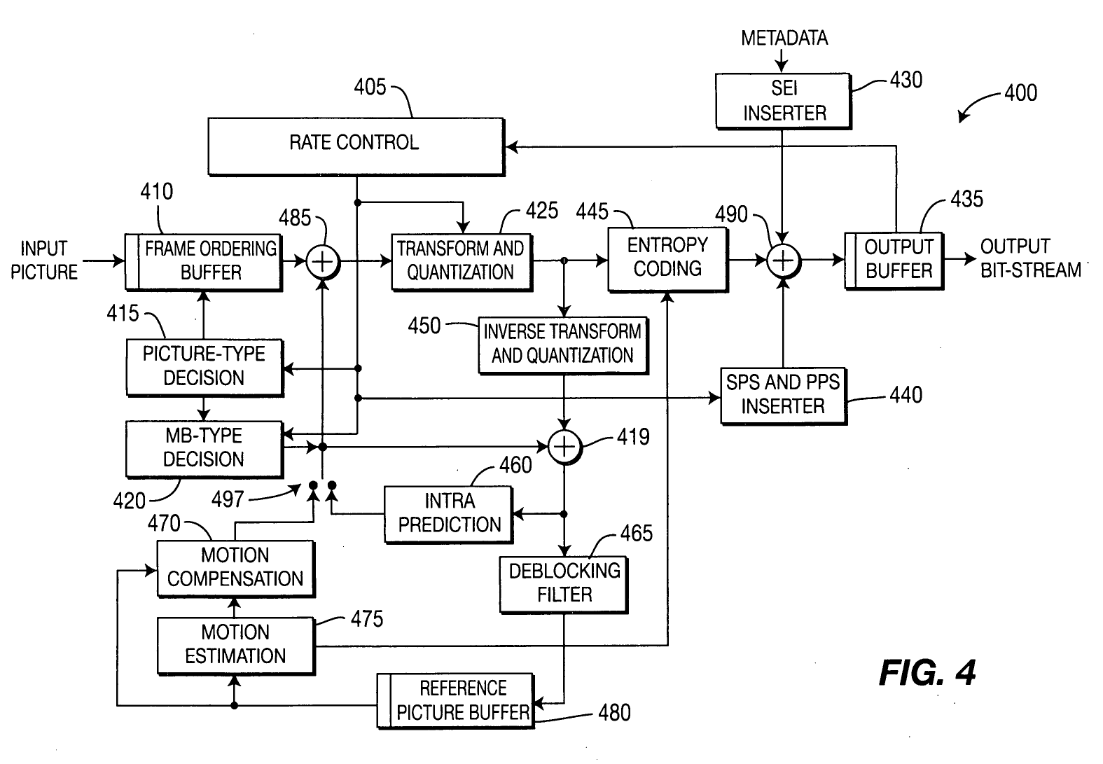

Turning to FIG. 4, an exemplary predictive video encoder to which the present principles may be applied is indicated generally by the reference numeral 400 that could apply the rate control algorithm in FIG. 3 with an integrated dark noise artifact detection module 495 implementing the dark noise artifact detection method of the present principles. The encoder 300 may be used, for example, as the encoder 340 in FIG. 3. In such a case, the encoder 400 is configured to apply the rate control (as per the rate controller 330) corresponding to the apparatus 300 of FIG. 3.

The video encoder 400 includes a frame ordering buffer 410 having an output in signal communication with a first input of a combiner 485. An output of the combiner 485 is connected in signal communication with a first input of a transformer and quantizer 425. An output of the transformer and quantizer 425 is connected in signal communication with a first input of an entropy coder 445 and an input of an inverse transformer and inverse quantizer 450. An output of the entropy coder 445 is connected in signal communication with a first input of a combiner 490. An output of the combiner 490 is connected in signal communication with an input of an output buffer 435. A first output of the output buffer is connected in signal communication with an input of the rate controller 405. An output of a rate controller 405 is connected in signal communication with an input of a picture-type decision module 415, a first input of a macroblock-type (MB-type) decision module 420, a second input of the transformer and quantizer 425, and an input of a Sequence Parameter Set (SPS) and Picture Parameter Set (PPS) inserter 440.

A first output of the picture-type decision module 415 is connected in signal communication with a second input of a frame ordering buffer 410. A second output of the picture-type decision module 415 is connected in signal communication with a second input of a macroblock-type decision module 420.

An output of the Sequence Parameter Set (SPS) and Picture Parameter Set (PPS) inserter 440 is connected in signal communication with a third input of the combiner 490. An output of the inverse quantizer and inverse transformer 450 is connected in signal communication with a first input of a combiner 427. An output of the combiner 427 is connected in signal communication with an input of an intra prediction module 460 and an input of the deblocking filter 465. An output of the deblocking filter 465 is connected in signal communication with an input of a reference picture buffer 480. An output of the reference picture buffer 480 is connected in signal communication with an input of the motion estimator 475 and a first input of a motion compensator 470. A first output of the motion estimator 475 is connected in signal communication with a second input of the motion compensator 470. A second output of the motion estimator 475 is connected in signal communication with a second input of the entropy coder 445.

An output of the motion compensator 470 is connected in signal communication with a first input of a switch 497. An output of the intra prediction module 460 is connected in signal communication with a second input of the switch 497. An output of the macroblock-type decision module 420 is connected in signal communication with a third input of the switch 497. An output of the switch 497 is connected in signal communication with a second input of the combiner 427.

An input of the frame ordering buffer 410 is available as input of the encoder 400, for receiving an input picture. Moreover, an input of the Supplemental Enhancement Information (SEI) inserter 430 is available as an input of the encoder 400, for receiving metadata. A second output of the output buffer 435 is available as an output of the encoder 400, for outputting a bitstream.

Additionally, the methods may be implemented by instructions being performed by a processor, and such instructions may be stored on a processor-readable medium such as, for example, an integrated circuit, a software carrier or other storage device such as, for example, a hard disk, a compact diskette, a random access memory (“RAM”), or a read-only memory (“ROM”). The instructions may form an application program tangibly embodied on a processor-readable medium. As should be clear, a processor may include a processor-readable medium having, for example, instructions for carrying out a process.

As should be evident to one of skill in the art, implementations may also produce a signal formatted to carry information that may be, for example, stored or transmitted. The information may include, for example, instructions for performing a method, or data produced by one of the described implementations. Such a signal may be formatted, for example, as an electromagnetic wave (for example, using a radio frequency portion of spectrum) or as a baseband signal. The formatting may include, for example, encoding a data stream, packetizing the encoded stream, and modulating a carrier with the packetized stream. The information that the signal carries may be, for example, analog or digital information. The signal may be transmitted over a variety of different wired or wireless links, as is known.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are within the scope of the following claims.

1. A method comprising the steps of:
filtering (14) an area of a digital image to eliminate an artifact within the area; and
assigning (16) a dark noise artifact parameter to the area.

2. The method of claim 1 further comprising the step of screening an area in said digital image based on luminance information relating to the area.

3. The method of claim 1 further comprising the step of screening an area in said digital image based on spatial activity information relating to the area.

4. The method of claim 1 further comprising the step of screening an area in said digital image based on texture information relating to the area.

5. The method of claim 1 further comprising the step of screening an area in said digital image based on temporal information relating to the area.

6. The method of claim 1, wherein said filtering comprises median filtering.

7. The method of claim 1, wherein said assigning of a dark noise artifact parameter is performed on a macroblock level.

8. The method of claim 1, wherein said assigning of a dark noise artifact parameter is performed on a picture level.

9. The method of claim 1, wherein the dark noise artifact detection is performed on a pixel domain.

10. The method of claim 1, wherein the dark noise artifact detection is performed on a transform domain.

11. The method of claim 1, wherein the digital images is one of a series of digital images in digital video content.

12. The method of claim 1 wherein said dark noise artifact parameter is compared to a threshold and said set of pixels is re-encoded in response to said dark noise artifact parameter exceeding said threshold.

13. The method of claim 1 wherein said dark noise artifact parameter is provided as a system output.

14. A video encoder comprising:
a detector (10) configured to eliminate dark noise artifacts within said area and assign a dark noise artifact parameter to said area.

15. The video encoder of claim 14, wherein the detector further comprises a media filter.

16. The video encoder of claim 14, wherein said detector is further operative to screen an area of a digital image for dark noise artifacts using luminance information of the area.

17. The video encoder of claim 14, wherein said detector is further operative to screen an area of a digital image for dark noise artifacts using spatial activity information.

18. The video encoder of claim 14, wherein said detector is further operative to screen an area of a digital image for dark noise artifacts using texture information.

19. The video encoder of claim 14, wherein said detector is further operative to screen an area of a digital image for dark noise artifacts using temporal information.

20. The video encoder of claim 14, wherein the encoder is compliant with at least one standard selected from a group consisting of MPEG-4 AVC, VC-1 and MPEG-2.

21. The video encoder of claim 14, wherein the digital image is part of a series of digital images making up video content.

22. The video encoder of claim 14, wherein the detector assigns the dark noise artifact parameter on a macroblock level.

23. The video encoder of claim 14, wherein the detector assigns the dark noise artifact parameter on a picture level.

24. The video encoder of claim 14 wherein said dark noise artifact parameter is compared to a threshold and said set of pixels is re-encoded in response to said dark noise artifact parameter exceeding said threshold.

25. The video encoder of claim 14 wherein said dark noise artifact parameter is provided as a system output.
